(19) United States
(12) Patent Application Publication
(10) Pub. No.: US 2007/0194922 A1
(43) Pub. Date: Aug. 23, 2007

(54) SAFE WARN BUILDING SYSTEM AND METHOD

(75) Inventors: John F. Nathan, Highland, MI (US); H. Winston Maue, Northville, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/675,199

(22) Filed: Feb. 15, 2007

Related U.S. Application Data
(60) Provisional application No. 60/774,815, filed on Feb. 17, 2006.

(51) Int. Cl. G08B 13/14; G08B 23/00; G08B 5/22

(52) U.S. Cl. 340/572.1; 340/573.1; 340/825.49

(57) ABSTRACT

A method and system for building safe warn. The building safe warn generally related to warning or otherwise alerting building occupants to hazards or other conditions in the building. The warnings may be generated as a function of occupant positioning with the building and/or the location of a hazard so as to facilitate safely evacuating the occupants from the building. The location of the occupants may be reported to emergency response entities to facilitate occupant discovery and rescue.

### CROSS-REFERENCE TO RELATED APPLICATIONS

This application claims the benefit of U.S. provisional application Ser. No. 60/774,815 filed Feb. 17, 2006, the disclosure of which is hereby incorporated in its entirety.

### BACKGROUND OF THE INVENTION

1. Field of the Invention

The present invention relates to safely warning building occupants of hazards within a building or other dwelling.

2. Background Art

In the case of emergency (Fire, tornado etc) in a building or other dwelling, conventional evacuation and hazard protection strategies rely on emergency authority (Fire Brigade, Police etc) to check each and every floor and to direct the personnel to come out of the building in the case of emergency situation. This approach has experienced limited success for safe and effective evacuation operation. A better mechanism or process is needed.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a building safe warn system in accordance with one non-limiting aspect of the present invention; and

FIG. 2 illustrates a flowchart of a method for alerting building occupants in accordance with one non-limiting aspect of the present invention.

### DETAILED DESCRIPTION OF THE PREFERRED EMBODIMENT(S)

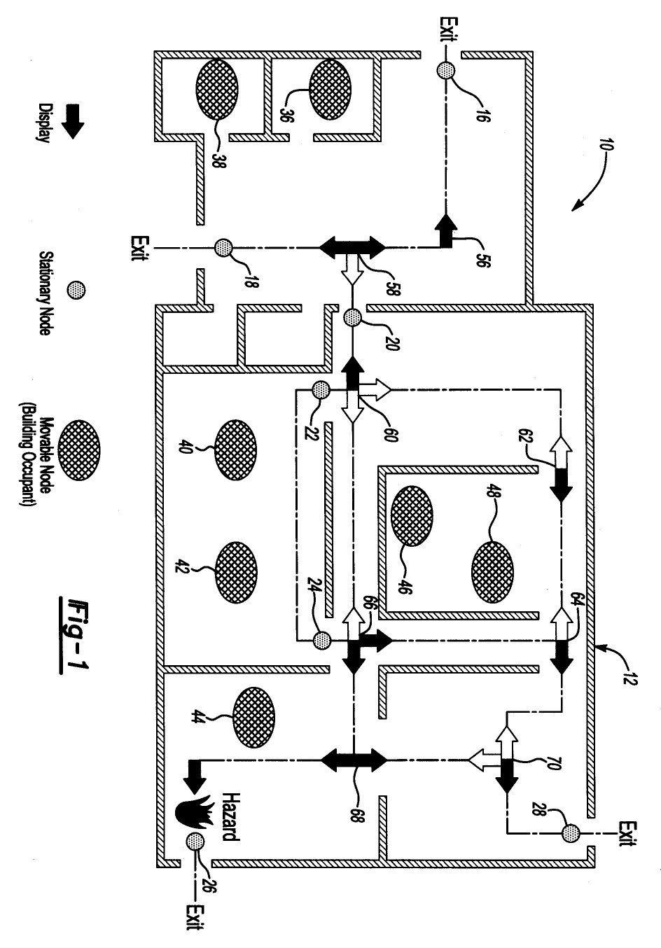

FIG. 1 illustrates a building safe warn system 10 in accordance with one non-limiting aspect of the present invention. The system 10 generally provides a method to facilitate evacuating, instructing, or otherwise communicating with building occupants during an emergency or other event in a building 12. FIG. 1 is shown with respect to a single floor in the building 12 for exemplary purposes. The present invention, however, is not so limited and fully contemplates emergency assistance in buildings having multiple floors and coordinating activities across the various floors.

The system 10 may include a number of stationary nodes 16-28 and mobile nodes 36-48. The nodes 16-48 may include enhanced capabilities, such as to facilitate processing data and bi-directional wireless or wireline communication, and/or limited capabilities, such as RF tags having capabilities to communicate limited amounts of information. Optionally, the stationary nodes 16-28 may be fixed to locations within the building 12 and the RF tags 36-48 may be carried on the person of the occupants. The RF tags 36-48 may communicate with the stationary nodes 16-28 to facilitate locating the occupants. The stationary nodes 16-28 may process this information with emergency alerts and other data to direct the occupants during an emergency. A number of signs or other displays 56-70 may be located throughout the building 12 and controlled to facilitate directing the occupants.

Each human (mobile) node 36-48 may be a smart ID card which can serve dual purpose as a building access card and moving node identification. This ID card may be of low cost and small in size having RF trans-receivers. It may operate with paper alkaline battery that will last long without maintenance for more than a year.

All the floors of the building 12 may be equipped with some fixed nodes or stationary nodes 16-48. The stationary nodes 16-28 may have the capability of communicating with each other using wireless technologies. Chosen wireless technologies may support mechanism to have more than one communication path (direct or using multiple hops) between any two stationary nodes. More than one floor may be severely affected during emergency and all stationary nodes 16-28 in that floor may become non-functional such that nodes may be able to communicate wirelessly with stationary nodes located 2-3 floors above/below.

Each floor may include various audio/visual indicators 56-70 that can be wirelessly controlled by a stationary node 16-28. During emergency, a predefined trigger is sent to all stationary nodes 16-28 to alert the stationary nodes 16-28 about the emergency. Stationary nodes 16-28 may then communicate with all the human nodes in its range of communication. Each stationary node 16-28 gathers the information about human node's ID and health related information in its close sphere of communication (using RF). This information may be shared with other stationary nodes 16-28 using wireless technology.

Each stationary node 16-28 may store some information about floor geometries, location of audio/visual indicators and exit routes. These layout related data and human node density distribution assists the stationary nodes to compute an optimal safe exit path for each floor. Stationary nodes 16-28 then communicate with the audio-visual signals to show appropriate symbols or play appropriate pre-recorded audible prompts. These audio visual signals are meant for safe evacuation of the human nodes from the building.

The wireless network of stationary nodes (also referred to as Wireless mesh) 16-28 inside the building may be connected to emergency node (Fire Brigade, Police car etc) located outside the building using a wireless technology. This emergency node may also have one rugged display panel. Emergency authority (Fireman) will be able to see the human node density distribution on each floor of the building in the display unit. This emergency node also may have access to the building's layout and exit sign locations etc. Human node density's distribution and building geometry related data may be collated together to show the actual movement of people inside the building. Emergency personnel can zoom in on any specific area of the floor and check the human node situation. Based on viewed data some stationary nodes can be advised to actuate audio-video signals for evacuation of human nodes roaming around in specific area.

Each emergency person (fireman, police staff etc) entering inside the building may be provided with a small palm-top type handheld rugged display and processing element (not shown). This display may be able to communicate with the stationary nodes of the floor over RF link. Fireman can then select certain section of the floor and check for human node densities or a particular node there. Since each human node also carries a health related information of the person, this information can appear as colored dots in the display panel. It can help the fireman to accord more priority to evacuate physically incapacitated persons in emergency situation.

Each floor of the building 12 may be equipped with an exit display panel at suitable locations in the floor. This panel can include a floor map, such as but not limited to the map shown in FIG. 1. It can be used for showing all the exit signs of the floor and directions of movement relative thereto. In the case of emergency human node can see the safe exit rout on this panel for a given floor, such as with LEDs mounted on the exit routs. Combination of LEDs will blink to indicate the safest possible exit route, quickest exit route, least congested route, etc. This exit rout related information can come from the nearest stationary node on wireless connection to the exit display panel.

The system 10 may include a central controller (not shown) for directing the stationary nodes and/or the nodes 16-48 themselves may include capabilities for executing intelligent algorithms to safely direct and manage an evacuations during emergency. In this manner, the nodes 16-48 can be directed from the central controller and/or if the central controller is lost or otherwise unavailable, the nodes can self-direct the operations. Optionally, the nodes 16-48 on each floor may direct operations with respect to that floor and if a node is lost other nodes 16-48 on the same of different floor may provide redundancy and execute the operations for the lost node 16-48.

The nodes 16-48 may include capabilities for storing special building characteristics, such as the weak sections (structurally), the weak trusses etc. in order to know and predict the sections or parts of the building that will collapse first during an emergency. The data can be sent to a responding fire truck to help emergency authorities plan an evacuation taking into consideration vital information about building characteristics. This information may also be used by the nodes when automatically generate the initial evacuation strategy to predict emergency management as a function of the building characteristics. e.g. having data for a particular zone or floor that stores inflammable material, (to indicate that this section is highly susceptible to fire). The evacuation system software may have special algorithms to detect the emergency in and around these highly critical zones and plan the evacuation.

The evacuation system 10 may have a feature for temperature monitoring. The evacuation system can periodically monitor the temperature data of the zones in the building. It can store temperature profiles for these zones in its database. Whenever the evacuation system finds a drastic change in a particular temperature profile or has a gradual upward trend, it can trigger a warning and use audio-visual indicators to alert the emergency entities about the abnormal conditions. The nodes 16-48 can include algorithm to determine and/or the nodes 16-48 can be instructed by the responding entity to provide response to emergency events and routing of the moving node (occupants) traffic in the safest way during emergency evacuation procedures by providing audio and visual alerts. The nodes 16-48 may include a disaster action plan which shall guide all the moving nodes during evacuation, which may consider various factors such as moving node density at particular exit point, distance of the exit doors from the moving nodes etc.

The stationary nodes 16-28 may be scattered throughout the building at strategic locations to track the moving nodes and assist them in evacuation during an emergency. The stationary nodes 16-28 may act as a RFID Reader/Scanner and/or a wireless transmitter/receiver. During normal mode of operation the stationary nodes may act as a standby unit waiting for a trigger. During this time these nodes c16-28 an transmit their status or ‘heartbeats’ to other nodes. Whenever system is triggered by any emergencies, the stationary nodes can switch from the ‘Alert’ state to the ‘Emergency’ state and start monitoring the human nodes.

The stationary nodes 16-28 in the hazard area can propagate the hazard information to the nearby nodes in a chain manner. The nodes 16-48 may have unique IP address, which can be easily configured and changed whenever, required. With this unique IP address it can be possible to remotely talk with a particular node for an upgrade to the firmware or diagnostics.

During normal mode of operation the stationary RFID nodes 16-28 may be placed in the ‘Alert’ mode and may not track any moving nodes. During normal mode of operation, they may only respond to pinging message from the command and control unit from other stationary nodes. The stationary nodes 16-28 may then transition to the ‘Emergency’ mode and then locate, track and report the human node status and also attempt to direct the evacuation. The stationary nodes 16-28 can transfer information and exchanging real-time data for aiding decision-making.

Exit signs may be located near the stairwell or the elevators. The signs may be configured for indicating the direction towards the exit, work as a radio beacon or a RFID/RF station that can monitor the human nodes to report the density, the location and the movement of the human nodes, monitor stairwell conditions, elevator conditions, lobby conditions etc. and report the same to the nodes for better planning of the evacuation, and/or the signs can be modified to direct the evacuation as per the commands received from other nodes unit by using Audio/Visual signs.

Emergency intercom phones may be installed in the zones to help communicate with a command/control center to help fine-tune the evacuation. These phones can also serve as a RFID scanner/reader or a wireless receiver. Video surveillance cameras can be used for visual identification and tracking of human nodes during emergency situations. These cameras may be fireproof and have suitable power back up to assist evacuation, as well as abilities to communicate with command and control unit by means of wireless or wired communication. IP cameras can also be used for visual identification and tracking of human nodes during emergency situations. The IP cameras can be directly connected to the network and can be accessed by IP address. Smoke detectors can also serve the purpose of a RFID Scanner/Reader or a wireless transmitter/receiver. The smoke detectors may have an independent power back up in case of power failure.

During emergency situation emergency authorities such as Fire Marshals, Security persons can use two-way hands free wireless communication devices. These devices enable instant two-way voice conversation without the need to remember a phone number or manipulate a handset. These wireless communication devices are controlled with naturally spoken commands. With the help of theses devices, emergency authorities can communicate with each other effectively to carry out the evacuation.

A command and control unit or authorized node may designated to communicate with all the moving nodes (Human nodes) and stationary nodes 16-28. It may processes all the data related to human nodes received from stationary nodes, the emergency zones and other related information and may direct the evacuation. The command and control unit may have abilities to provide 3D pictorial representation of complete building structure including rooms, lobbies, passages and staircases on an emergency proof video display unit. During emergency, this unit may display the current location of every human node in a zone as received by the stationary node in that zone. The Unit shall also be able to identify the human node, the node density, the level or the intensity of the hazard in that zone to help plan the evacuation.

Modern buildings have several control systems built-in to ensure a proper functioning of the building. These control systems could be the Building management systems, the elevator systems, the HVAC systems, the communication systems etc. The communication systems, in this case may include several different networks that operate independently to carry host of sensor information to control systems. Information form these system can be obtained and communicated on a real-time basis en-route to the scene of incidence through wireless technology and also with the fire/rescue departments. The system may be designed with the capability of communicating this wealth of valuable information during an emergency out of the building and to the emergency entity, which could be a wireless docking station with a visual display unit or a mini-evacuation system within the fire-truck or the ambulance.

During the emergency situations the stationary nodes 16-28 may start monitoring the human nodes 36-48. The firmware for these stationary nodes (RFID readers) 16-28 may have smart algorithms to search which are the neighboring nodes within its vicinity, which are the nearby safe exit routes available, to which of the neighboring nodes 16-48 it should propagate the hazard situations, for which of the neighboring nodes it should act as a backup in case they fails etc. By way of using these smart algorithms stationary nodes 16-28 may be able to decide which will be the safest and optimal exit path for the people trapped in the emergency. These nodes 16-28 can then guide the people in the building for evacuation based on these smart algorithms by means of Audio/Visual indicators.

An in-vehicle PC may be installed in the vehicles such as fire truck or ambulance, which can aid rescue team in carrying out evacuation. When the vehicle is within a range of around 500 meters from the building the Fire marshals can start communicating with the evacuation system components in the building and get the real time information about the evacuation status. The in-vehicle PC should be equipped with all the 3-D pictorial representation of the building floor plans which will guide the rescue persons for the real time tracking of the moving nodes 36-48 in the affected areas and support wireless communication.

A geographic information system computer-based tool may be used for mapping and analyzing things that exist and events that happen. In the system it may show the real time movement of the human nodes 36-48 present in the building, the hazard location, the status of various stationary nodes 16-28 etc. This should show 3D pictorial representation of the building schematics with real time movement of human nodes in the building. GIS technology may integrate database operations such as query and statistical analysis with the unique visualization and geographic analysis benefits offered by maps. Because of these abilities with the help of GIS, it becomes vary easy for explaining events, predicting outcomes, decision making, planning strategies and co-ordination during an emergency situation.

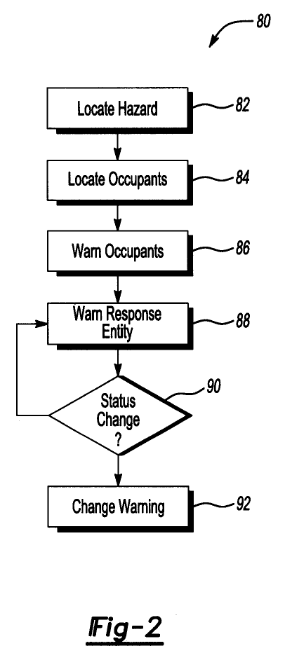

FIG. 2 illustrates a flowchart 80 of a method for alerting building occupants in accordance with one non-limiting aspect of the present invention. The method may be embodied and/or partial executed through operations stored in a computer-readable medium or other logically processing element, such as but not limited to one of the above-described nodes. The method may be used with any type of building or dwelling to alert occupants to any number of conditions within the building.

Block 82 relates to locating a hazard or other condition within the building. The hazard may be automatically located as a function of signals received from one or more alarms or other detection devices. These devices may be configured to broadcast or otherwise transmit signals associated with the hazard to one or more nodes provided throughout the building. The nodes may be wireless connected to each other in order to facilitate distributing the alarm throughout the building.

Block 84 relates to locating building occupants in response to the hazard. The occupants may be located according to any suitable locating process, including the occupants as a function of the location of the wireless RF tags carried on the occupants relative to the nodes. Each node may be assigned to monitor or otherwise keep track of occupants within a particular portion of the building. The nodes may have redundancy whereby one node may be assigned to track occupants in another portion of the building should one the primary tracking node fail.

Block 86 relates to warning the building occupants. The warning may include displaying information on one or more displays located throughout the building. The displays be in communication with the nodes such that the nodes command the displays to show particular information. The information may be selected as function of the hazard and the location of building occupants with respect to the same. Different displays may display different information depending on the location of the display with respect to the hazard and desired movement of the occupants with respect to the display.

Optionally, the displayed information may correspond with an evacuation strategy automatically determined by the nodes based on the hazard and occupant locations. The evacuation strategy may provide a means for directing the occupants to safely evacuate the building, such as according to a safest or fastest route, and/or it may instruct the occupants to take other action, such as applying gas masks or taking shelter. The strategy may vary from one building location to another.

Block 88 relates to warning an emergency response entity to the location of the hazard, including information regarding its scope, type, etc., and/or the location of the occupants. This information may be electronically communicated to the response entity such that a layout of the building may be shown to the responders with an illustration of the hazard and occupant locations. The responders may include handheld devices to facilitate locating occupants while moving throughout the building.

Block 90 relates to determining status changes. The status change may relate to changes in the progress of the hazard, such as a fire spreading throughout the building, change in the occupant locations, such as with movement of occupants as they attempt to evacuate the building, and/or changes in evacuation strategy as specified by the response entity. If no significant changes have occurred, Block is returned to the current warnings and display information may be maintained.

If significant changes has occurred, Block 92 may be reached and the displayed information may be changed. The information may be changed to reflect any number of changes in condition and/or evacuation strategy, such as re-directing occupants away from a congested exit or change in the hazard and/or re-directing occupants according to a new evacuation strategy from the response entity.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of alerting building occupants within a building to hazards, the method comprising:
locating a hazard within the building as function of signals received from one or more sensors within the building;
locating one or more building occupants as a function of wireless signal communications with RF tags carried on the building occupants; and
alerting the occupants to the hazard as a function of a location of the occupants relative to the hazard.

2. The method of claim 1 further comprising alerting occupants at a first location in the building with a first alert and alerting occupants in a second location of the building with a second alert, the second alert being different than the first alert.

3. The method of claim 2 further comprising varying the first and second alerts as a function of a location of a display used to display the alerts, the location of the hazard, and the location of one or more of the occupants.

4. The method of claim 1 further comprising alerting the occupants to move away from the hazard depending on the location of the occupants relative to the location of the hazard.

5. The method of claim 4 further comprising re-directing the occupants as a function of changes in the hazard.

6. The method of claim 4 further comprising re-directing the occupants as a function of the occupants changing locations.

7. The method of claim 1 further comprising alerting a hazardous response entity to the location of the hazard and the occupants.

8. The method of claim 7 further comprising alerting the occupants as a function of instructions received from the hazardous response entity.

9. The method of claim 7 further comprising providing a graphical representation having a layout of the building and the location of the hazard and occupants to the response entity.

10. The method of claim 9 further comprising electronically communicating the graphical representation to the response entity.

11. A safety system for use in a building having a number of occupants, the system comprising:
a number of wireless devices carried on occupants for use in locating the occupants;
one or more alarms within the building for sensing occurrence of one more predefined safety related events; and
a controller in communication with the wireless devices and the one or more alarms, the controller configured to automatically generate an evacuation strategy to facilitate safely exiting the occupants from the building, the evacuation strategy being determined at least in part as a function of the location of the occupants and the alarms.

12. The system of claim 11 further comprising one or more displays within the building to facilitate directing the occupants out of the building in accordance with the evacuation strategy.

13. The system of claim 11 further comprising adjusting the evacuation strategy according to instructions received from a wireless device carried by an emergency response entity.

14. The system of claim 12 wherein the controller is configured to adjust the evacuation strategy with movement of the occupants throughout the building.

15. A safety system for use in a building having a number of occupants, the system comprising:
a number of wireless devices carried on occupants for use in locating the occupants; and
a number of stationary nodes positioned throughout the building, the nodes forming mesh network for communication with the wireless devices, wherein each nodded is configured to automatically generate an evacuation strategy to facilitate safely exiting the occupants from the building, the evacuation strategy being determined at least in part as a function of the location of the occupants.

16. The system of claim 15 wherein a portion of the nodes are assigned to direct evacuation of the portion of the occupants, and wherein if the one of the nodes fail, one or more of the others nodes is assigned to evacuate the occupants associated with the failed node.

17. The system of claim 15 wherein at least one of the nodes is an emergency response node configured to communicate with an emergency response entity.

18. The system of claim 17 wherein the emergency response node is configured to communicate occupant locations to the emergency response entity.

19. The system of claim 18 wherein the emergency response entity includes a hand-held locating device to facilitate locating the occupants.

20. The system of claim 15 further comprising a number of displays within the building, the node being configured to control the displays to facilitate evacuating the occupants.
